(19) United States
(12) Patent Application Publication
(10) Pub. No.: US 2009/0200777 A1
(43) Pub. Date: Aug. 13, 2009

(54) Apparatus and method for controlling an inflatable cushion

(76) Inventors: James L. Webber, Shelby Township, MI (US); Jason W. Brown, West Carrollton, OH (US)

Correspondence Address: DELPHI TECHNOLOGIES, INC., M/C 480-410-202, PO BOX 5052, TROY, MI, 48007, US

(21) Appl. No.: 12/069,906

(22) Filed: Feb. 13, 2008

(51) Int. Cl. B60R 21/26

(52) U.S. Cl. 280/735; 280/736

(57) ABSTRACT

An air bag module, comprising: an inflatable cushion being configured for deployment from the air bag module; an inflator for inflating the inflatable cushion, the inflator being in fluid communication with the inflatable cushion, the inflator comprising a first initiator for initiating a first stage of inflation and a second initiator for use with the first initiator for initiating a second stage of inflation, the first stage of inflation providing a first inflation output to the inflatable cushion and the second stage producing a second inflation output to the inflatable cushion, the second inflation output being greater than the first inflation output; a deployable member, the deployable member being deployed in a first direction either before or during the first stage of inflation; and wherein unobstructed deployment of the deployable member in the first direction will cause an activation signal to be sent to the second initiator to initiate the second stage of inflation.

### TECHNICAL FIELD

This present invention relates generally to airbags or inflatable cushions for vehicles. More specifically, the present invention relates to systems and methods for controlling the deployment of an inflatable cushion of an airbag module.

### BACKGROUND

Airbag modules have become common in modern automobiles. An airbag module typically comprises an inflatable cushion and an inflator within a housing. The module is installed in a desired position within the vehicle, such as the steering wheel, the dashboard, the seat, vehicle doors; the A-pillar, and other locations. The inflatable cushion is stored in a folded position within the housing in fluid communication with the inflator. In response to an activation event or occurrence, a sensor provides a signal for activating the inflator. The inflator provides a supply of inflating gas to the cushion to inflate the cushion, deploying it from the housing into the vehicle.

Various methods have been employed to tie the inflation level of the inflatable cushion to specific conditions.

Accordingly, it is desirable to provide an airbag module with an apparatus or system that can provide a signal to vary the inflation rate or venting rate of the airbag module.

### SUMMARY

Disclosed herein is a device and method for manipulating the deployment characteristics of an inflatable cushion of an airbag module. Exemplary embodiments of the present invention are directed to a method and apparatus to change the level of inflation of a passenger side airbag based on an occupant's or other object's proximity to the deploying airbag. In one exemplary embodiment a small foam plug or deployable member is propelled through the folded cushion toward an area proximate to the airbag module wherein the deployable member is propelled using the inflation forces of the first stage of the inflator. In this embodiment, a thread attached to the plug pulls a switch to signal the sensing and diagnostic module that the deployable member has not encountered an obstruction and the signal is used to enable the second inflator stage. In another exemplary embodiment, a contact-type electro-mechanical sensor will determine if an occupant or other object is close to the deploying inflatable cushion in this embodiment if the occupant is in close proximity the deployment is suppressed alternatively, the cushion will fill with the needed energy to fully inflate the cushion. In this embodiment either a separate squib or the inflator energy is used to deploy the contact sensor.

In accordance with an exemplary embodiment, an air bag module for use in a vehicle is provided. The air bag module, comprising: an inflatable cushion being configured for deployment from the air bag module; an inflator for inflating the inflatable cushion, the inflator being in fluid communication with the inflatable cushion, the inflator comprising a first initiator for initiating a first stage of inflation and a second initiator for use with the first initiator for initiating a second stage of inflation, the first stage of inflation providing a first inflation output to the inflatable cushion and the second stage producing a second inflation output to the inflatable cushion, the second inflation output being greater than the first inflation output; a deployable member, the deployable member being deployed in a first direction either before or during the first stage of inflation; and wherein unobstructed deployment of the deployable member in the first direction will cause an activation signal to be sent to the second initiator to initiate the second stage of inflation.

In accordance with another exemplary embodiment, an air bag module for use in a vehicle is provided. The air bag module, comprising: an inflatable cushion being configured for deployment from the air bag module; an inflator for inflating the inflatable cushion, the inflator being disposed within a plenum, the plenum comprising a first plurality of openings in fluid communication with the inflatable cushion, a second plurality of openings in fluid communication with an exterior of the airbag module; and a conduit in fluid communication with a plate housing; a deployable member slidably received within the plate housing, the deployable member being deployed in a first direction during activation of the inflator; a rotary valve rotatably disposed within the plenum the rotary valve being configured to transition from a first position to a second position, wherein the first plurality of openings are blocked by the rotary valve in the first position and second plurality of openings are unblocked by the rotary valve in the first position; and wherein unobstructed deployment of the deployable member in the first direction will cause the rotary valve to transition from the first position to the second position, wherein the first plurality of openings are unblocked by the rotary valve in the second position and the first plurality of openings are blocked by the rotary valve in the second position.

In accordance with another exemplary embodiment, a proximity detection device for use in a vehicle is provided. The proximity detection device, comprising: a deployable member, the deployable member being deployed in a first direction either before or during inflation of the inflatable cushion; and wherein unobstructed deployment of the deployable member in the first direction will cause an inflation output to the inflatable cushion to be increased.

In accordance with another exemplary embodiment, a method for determining whether a portion of an inflatable cushion of an airbag module is obstructed is provided. The method comprising: deploying a deployable member in a first direction; increasing an inflator output to the inflatable cushion if the deployable member reaches a predetermined distance, wherein the deployable member is not an inflatable item.

The above-described and other features of the present application will be appreciated and understood by those skilled in the art from the following detailed description, drawings, and appended claims.

### DRAWINGS

FIG. 1 is a partial view of a vehicle interior showing an air bag module and inflatable cushion in a stored or un-deployed state;

FIGS. 2A and 2B are perspective views of an airbag module constructed in accordance with an exemplary embodiment of the present invention;

FIG. 3 is a perspective view of component parts of an exemplary embodiment of the present invention;

FIGS. 4A-4C are views illustrating deployment of a proximity detection device constructed in accordance with an exemplary embodiment of the present invention;

FIGS. 5A-5C are views illustrating deployment of a proximity detection device constructed in accordance with an exemplary embodiment of the present invention;

FIGS. 6A and 6B are views illustrating a proximity detection device constructed in accordance with an alternative exemplary embodiment of the present invention;.

FIG. 7 is a view along line 7-7 of FIG. 6A;

FIGS. 8A-9D are views illustrating deployment of a proximity detection device constructed in accordance with an alternative exemplary embodiment of the present invention;

FIGS. 10A-10B are views illustrating deployment of a proximity detection device constructed in accordance with another alternative exemplary embodiment of the present invention;

FIGS. 11A-13B are views illustrating component parts of a proximity detection device constructed in accordance with another alternative exemplary embodiment of the present invention; and

FIGS. 14A-14B are views illustrating deployment of a proximity detection device constructed in accordance with another alternative exemplary embodiment of the present invention.

### DESCRIPTION OF EXEMPLARY EMBODIMENTS

Disclosed herein is a method and apparatus for selectively controlling the deployment or inflation of an inflatable cushion of an airbag module through the use of a deployable member disposed within and/or proximate to the inflatable cushion. In accordance with an exemplary embodiment, a force sufficient for deployment of the deployable member is provided. In addition, an inflation force is also provided by an inflator to inflate the inflatable cushion, in one embodiment the inflator comprises a first initiator for initiating a first stage of inflation and a second initiator for use with the first initiator for initiating a second stage of inflation, the first stage of inflation providing a first inflator output to the inflatable cushion. During the first stage of inflation the deployable member is deployed in a first direction, wherein unobstructed deployment of the deployable member in the first direction will cause a signal to be ultimately sent to the second initiator to initiate the second stage of inflation. If, however, the deployable member does not deploy in an un-obstructed manner no activation signal will be sent to the second initiator and only the first initiator will be fired.

In accordance with one exemplary embodiment the inflator is a dual stage inflator capable of providing two inflation outputs at selected times. Of course, other types of inflators maybe used in accordance with exemplary embodiments of the present invention. Non-limiting examples of exemplary inflators include but are not limited to pure gas inflators, hybrid inflators, pyrotechnic inflators, and equivalents thereof.

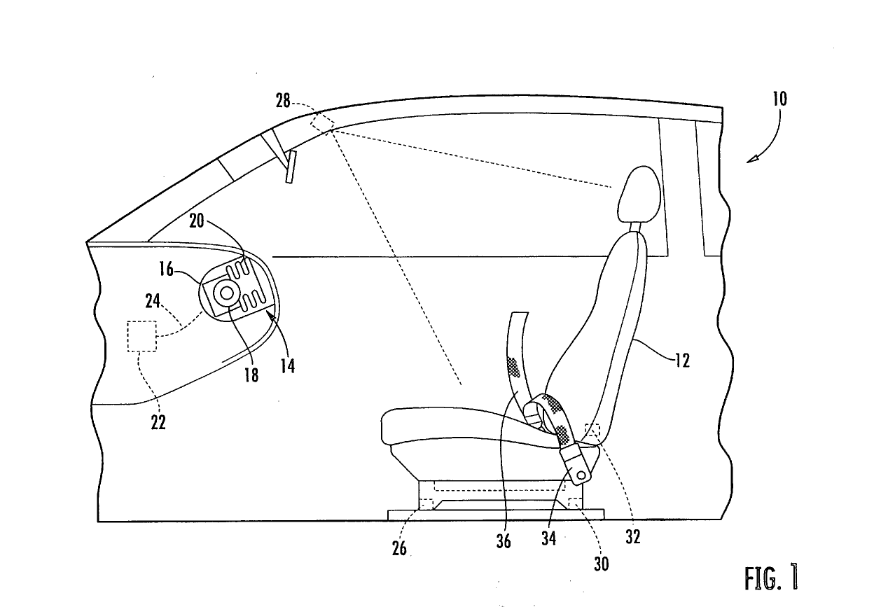

Referring now to the Figures, and in particular to FIG. 1 a portion of an interior of a vehicle 10 is illustrated. Included in the interior compartment of the vehicle is a seating structure 12 and an air bag module 14 disposed in a selected spatial relationship with respect to seating structure 12. The air bag module 14 comprises a housing 16, an inflator 18, and an inflatable air bag or cushion 20. The module 14 is positioned in the vehicle 10 for deployment of the cushion 20 towards the seating structure 12.

A sensor or sensing-and-diagnostic module 22 is adapted to detect an activation event wherein the occurrence of a threshold event will cause an activation signal 24 to be generated and received by the inflator 18, thereby causing the inflator to inflate the inflatable cushion. The detection of the threshold event is determined by one or more sensors, which are disposed about the vehicle in accordance with known technologies. Thus, the activation signal 24 controls the activation of the airbag module 14. In an exemplary embodiment sensing-and-diagnostic module 22 comprises a microprocessor, microcontroller or other equivalent processing device capable of executing commands of computer readable data or program for executing a control algorithm that controls the operation of the airbag module. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include input signal filtering to enable accurate sampling and conversion or acquisitions of such signals from communications interfaces. As described above, exemplary embodiments of the present invention can be implemented through computer-implemented processes and apparatuses for practicing those processes.

The inflatable cushion is stored in a folded or un-deployed position in housing 16. The cushion is positioned to be in fluid communication with the inflator 18 wherein generation of the inflating gas will cause the cushion to inflate. Upon detection of an activation event by the sensing-and-diagnostic module 22, the inflator 18 is activated via signal 24 to generate the inflation gas. The inflation gas causes the cushion 20 to inflate and expand from housing 16 into the interior of the vehicle. It should be recognized that module 14 is illustrated by way of example only as being included in the dashboard of the vehicle. Of course, it is contemplated that module 14 can be installed for deployment in other regions of the vehicle, such as, but not limited to a forward facing position, a mid-mount location, the steering wheel, the seat, the A-pillar, the roof, and other locations as well as other angular or positional relationships illustrated in FIG. 1. Moreover, the specific configurations of the vehicle interior, instrument panel, windshield, airbag module and relationship with regard to the same are provided as an example and it is, of course, understood that these configurations may vary from the specific configurations illustrated in FIG. 1.

Additionally, the present disclosure is also contemplated for use with various types of inflatable cushions and inflators. For example, cushions which are folded in a particular manner to achieve various deployment configurations and various types of inflators (e.g., dual stage inflators).

In addition, and in accordance with the alternative exemplary embodiments of the present invention, the sensing-and-diagnostic module can also be adapted to detect one or more conditions of the seating structure. For example, sensing-and-diagnostic module 22 can be adapted to detect one or more of the following: a load or amount of load (e.g., occupant weight) on the seating structure 12, a position of the seating structure, an angle of a portion of the seating structure with respect to another portion, the distance the seating structure is from the air bag module 14, and other data that is relevant to the deployment of the airbag by receiving input from a plurality of sensors disposed about the vehicle.

For example, the sensing-and-diagnostic module can receive inputs from one or more sensors such as, but not limited to, a seat position sensor 26, an optical scanner 28, a load sensor 30, a seat recline sensor 32, a seat belt use detection sensor 34, and a belt tensioning sensor (not shown). The sensors are positioned to provide input signals to module 22 indicative of one or more seat conditions. The one or more seat conditions combined with an occupant's size (e.g., weight determined by sensors) is inputted in a control algorithm resident upon a microprocessor disposed within the sensing and diagnostic module in order to determine a desired deployment scheme for the inflatable cushion. For example, the data inputs when compared to a look up table stored in the memory of the microprocessor or other readable format will allow the algorithm to determine whether a full deployment or partial deployment of the airbag is desired (e.g., tailoring of the airbag module by activating or not activating a system designed to modify the cushion deployment characteristics).

The continuous sampling of the various sensors allows the sensing and diagnostic module to be provided with various inputs before an activation event (deployment) occurs. It is noted that the airbag inflation system of the present disclosure is contemplated for use with any combination of the aforementioned sensors and it is not intended to be limited by the specific types of sensors discussed above.

The seat position sensor detects the position or distance of seating structure 12 with respect to air bag module 14. Similarly, the optical scanner 28 can be used to detect the position of seating structure 12. The load sensor 30 is disposed within the seating structure 12 and can be used to detect the load on the seating structure. Thus, sensor 30 is capable of detecting the specific weight or load on a portion of seating structure 12. The seat recline sensor 32 can be used to detect the degree or angle to which an upper or back portion of the seating structure 12 is reclined or positioned with respect to a lower or seat portion of seating structure 12. The seat belt use detection sensor 34 can determine whether the seat belt 36 is secured (e.g., buckled is inserted into its corresponding clasp). The seat belt tensioning sensor, alone or in combination with the load sensor 30, can also be used to determine the load on the seating structure 12.

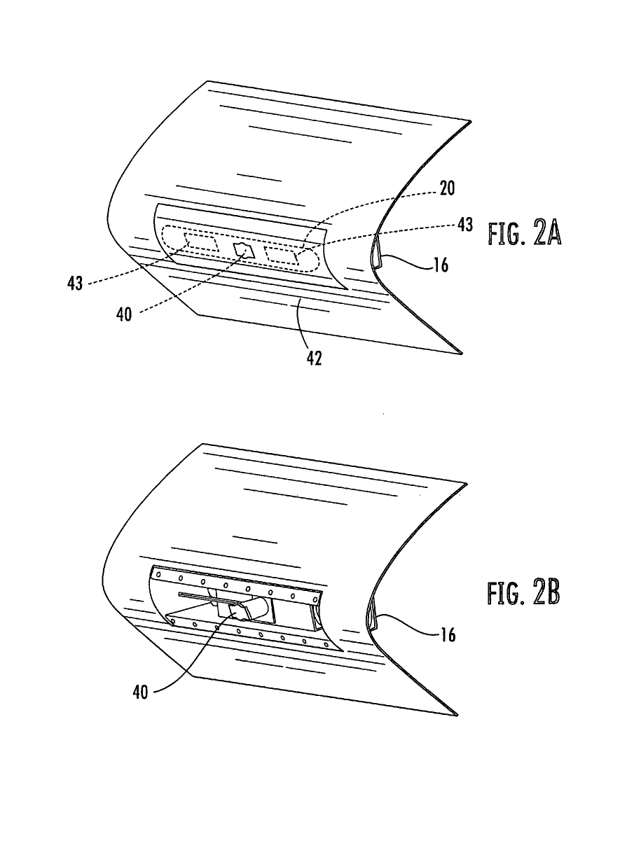

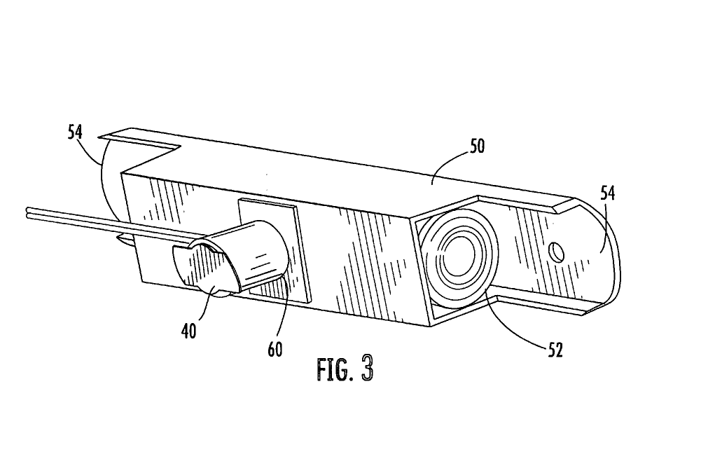

In accordance with an exemplary embodiment of the present invention and referring now to FIGS. 2A-4C, inflation energy or gas input to the cushion is controlled by a deployable member 40, which is located behind a deployable door 42 of a portion of an instrument panel 44. Deployable member 40 is centrally located within the inflatable cushion, wherein the inflatable cushion 20 is disposed about the deployable member to allow the same to deploy from the instrument panel of the vehicle. In accordance with an exemplary embodiment, the deployable member is position to deploy from the inflatable cushion from an opening in the inflatable cushion, which closes up after the inflatable cushion is fully inflated and after the deployable member has passed therethrough. An example of such a cushion is an inflatable cushion with an opening positioned about deployable member 40, wherein the interior surface of the inflatable cushion has a flap 43, which is unfurled as the inflatable cushion is inflated and the flap covers the opening after the deployable member has passed therethrough. In accordance with an exemplary embodiment, the inflatable cushion may comprise one or two flaps which are folded within the inflatable cushion proximate to the deployable member and are configured to unfurl (e.g., deploy) and cover the deployment opening after the deployable member has passed therethrough and the signal has been received to fire the second initiator of the inflator.

In accordance with an exemplary embodiment, the unobstructed deployment of member 40 will cause a sensing device 46 to provide a signal to the sensing and diagnostic module or directly to the inflator. It is also noted that sensing device 46 may be used with any of the aforementioned sensors to provide inputs or signals to the sensing and diagnostic module or alternatively sensing device 46 may be the only device used to determine whether a second stage of the inflator is to be activated. In accordance with an exemplary embodiment the signal generated by sensing device 46 is provided to the sensing and diagnostic module for use in control logic wherein the sensing and diagnostic module provides an activation signal to the second initiator if the required signals are received by the sensing and diagnostic module.

In an exemplary embodiment, the inflator is a dual stage inflator having a first initiator for providing a first low inflation stage and a second initiator for use with the first initiator in order to provide a second inflation stage. In an exemplary embodiment the first initiator and the second initiator are pyrotechnic squibs that fire in response to an activation signal. Of course, other equivalent devices are contemplated to be within the scope of the present invention. In one exemplary embodiment, the second inflation stage provides a higher level of inflator output to the inflatable cushion than the first inflation stage. An example of the inflator output or pressures provided by only the first initiator are approximately 227 kilopascal (kPa), measured in a 60 liter tank, while the inflator output or pressure provided by only the second initiator are 432 kPa for a total combined pressure of 615 kPa. Such a dual stage inflator is designated as (615kPa/227 Kpa) which means if the primary initiator or first initiator is fired 227 kPa will be generated in the 60-liter tank and if both the primary and secondary are fired 615 kPa will be generated in the 60-liter tank. Of course, it is understood that the pressures (e.g., inflator gas output) associated with the first and second initiators may vary to levels greater and less than the aforementioned values. In addition, and in alternative exemplary embodiments the pressures provided by the first initiator and the second initiator may be equal or alternatively the pressures provided by the first initiator may be greater than the second initiator.

The variation of the inflator output provided by the first and second initiators and resulting inflating force of the inflating cushion may ultimately depend upon a variety of factors including the location of the airbag module within the vehicle and the possible locations of the vehicle seat. In an exemplary embodiment, the second inflation stage is provided to fully inflate the inflatable cushion. The gas volume delivered to the cushion (at a certain temperature and pressure) determines, in part, the force an inflating cushion will generate. Accordingly, the amount of force generated by the inflating cushion depends in part on the available volume as well as the inflator output and time after initial inflator activation. Exemplary embodiments of the present invention are directed to a deployable member disposed within or adjacent to the inflatable cushion. The deployable member will be inflated when an activation signal is sent to the first initiator and the deployable member will provide an activation signal to the second initiator if the inflatable member is able to deploy in an un-obstructed manner. If, however, the deployable member does not deploy in an un-obstructed manner no activation signal will be sent to the second initiator and only the first initiator will be fired.

The air bag module includes an outer housing 16 for mounting to or proximate to an instrument panel or interior surface of a vehicle by suitable means such as fasteners. Of course, the module is contemplated for mounting to other structures in the vehicle. The housing is made of an easily molded or extruded rigid material such as plastic, steel, aluminum etc. As will be described in detail below, air bag module 14 comprises means to customize or tailor the inflation level of the inflatable cushion 20. The inflation level is commensurate with unobstructed deployment of the inflatable cushion. More specifically, and in accordance with an exemplary embodiment, deployable member 40 will deploy outwardly away from air bag module 14 in a first direction defined generally by arrow 48. Once the deployable member reaches a full deployment defined by a distance “X” away from the airbag module, the fully and unobstructed deployment of deployable member 40 will cause sensing device 46 to generate a signal. The signal will indicate that deployable member has fully deployed or is unobstructed and the signal will cause second initiator to fire thereby initiating the second stage of inflation wherein the inflatable cushion will reach its full deployment configuration.

In accordance with an exemplary embodiment, deployable member 40 will be deployed with gas generated by the first low stage of inflation, which in one embodiment comprises approximately 30 percent of the overall inflator output generated by the inflator when both initiators are fired. Of course, the amount of inflator output corresponding to the first low inflation stage might vary to be greater or less than the aforementioned values. For example, the first low stage of inflation may comprise greater or less than 30 percent of the overall inflation output generated by the inflator if both initiators are fired. Other percentages include, but are not limited to, 50 percent of the overall inflation output of both initiators or, if applicable, greater than 50 percent of the overall inflation output or pressures provided by both initiators the inflator.

Referring back now to FIGS. 2 and 3 the inflatable cushion is mounted to housing 16 by a mounting member 50, which defines an inner area 52 for receiving inflator 18 therein. As illustrated, area 52 is open at either end and mounting member 50 comprises flange portions 54 that extend away from the openings into area 52. Flange portions 54 also provide a means for securing a portion of the deployable member to housing 16. The configuration of member 50 provides at least two functions, the first being the securement of the deployable member to the bottom wall 56 of the housing, while the second function is the providing or defining a fluid flow path into openings of the deployable member that are disposed on either side of the inflator, which is located within area 52. It is also noted that in accordance with an exemplary embodiment inflator 18 is capable of providing inflation gas at both ends of opening 52. Accordingly, mounting member 50 provides a means for securing inflator 18 and deployable member 40 to housing 16 as well as defining fluid flow paths for deployable member 40.

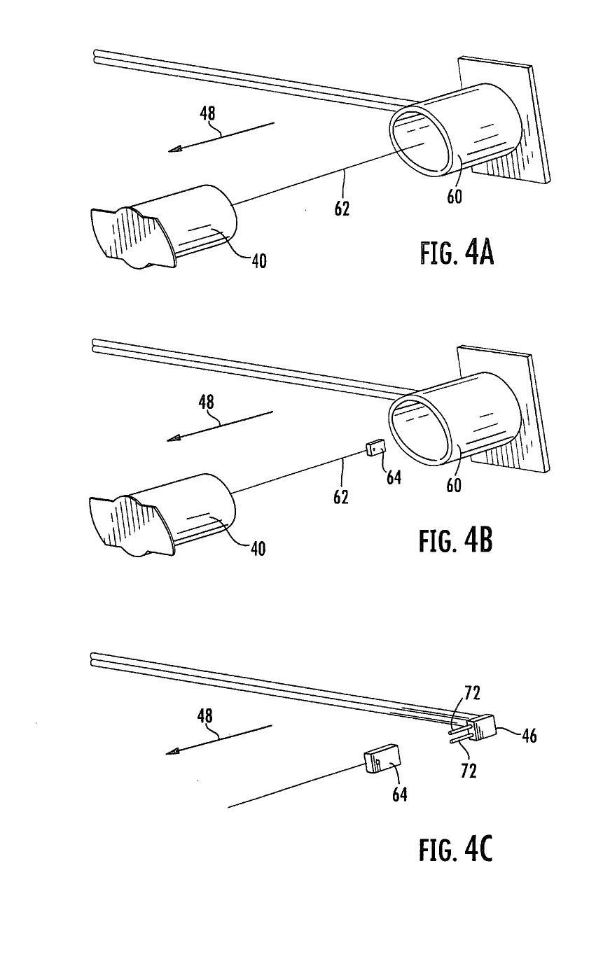

As illustrated in FIGS. 3-4B deployable member 40 is slidably received within a launch tube 60. Launch tube 60 is open at either end so that inflation gas pressure may enter at one end and apply the deployable member of the other. In accordance with an exemplary embodiment deployable member 40 is a foam plug having a thread or cable 62 secured to the foam plug at one end and a shorting clip 64 at the other. As illustrated, foam plug 40 has a cylinder portion and a blunt or mushroom shaped forward edge portion. Of course, other configurations are contemplated to be within the scope of the present invention. In accordance with an exemplary embodiment the length of the thread is equivalent to the distance the deployable member has to travel before sending a signal to the second initiator of the inflator. As illustrated in FIG. 4C, the deployable member has traveled the necessary distance thereby removing the shorting clip from sensor 46, which in this embodiment will provide a signal to the sensing and diagnostic module when the conductive path between a pair of terminals 72 of the sensor is removed by the movement of shorting clip 64. Therefore, control logic of the sensing and diagnostic module can be easily configured to determine whether the shorting clip has been removed. In addition, the sensing and diagnostic module can easily determine whether the power has been cut or there is a short-circuit in the system. In each of these cases the control logic of the sensing and diagnostic module will be configured to provide an appropriate output signal. It is, of course, understood that the aforementioned illustration of sensing element 46 is provided as a non-limiting example and any other means for providing an output signal in response to a fully deployed deployment member is contemplated to be within the scope of the present invention.

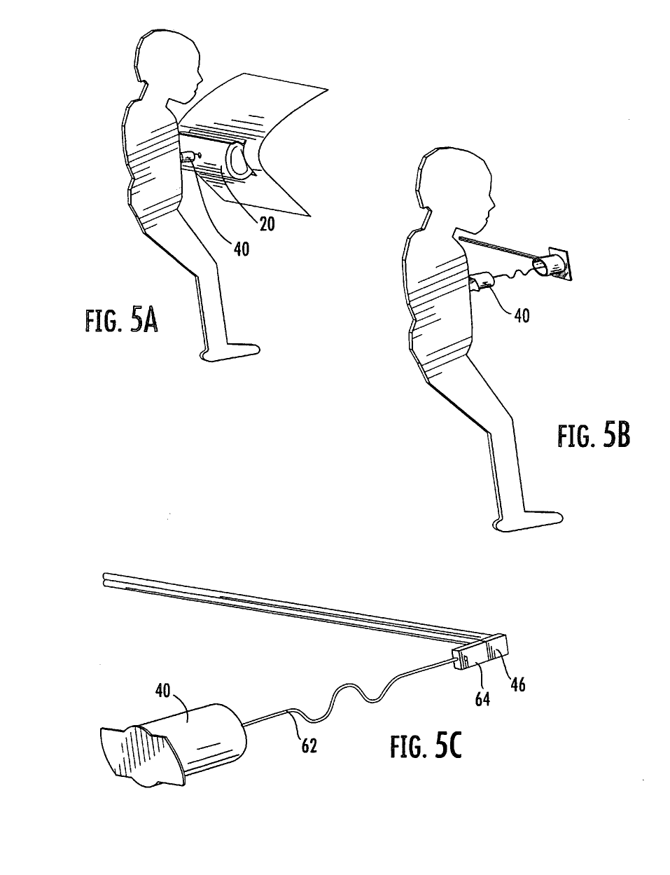

Referring now to FIGS. 5A-5C various configurations of obstructed deployment of deployable member 40 are illustrated wherein the foam plug has not traveled the required distance and shorting clip 64 remains secured to sensor 46.

In accordance with an exemplary embodiment of the present invention, deployable member 40 provides a proximity sensor that is fully deployed when a first stage of the inflator is activated. In accordance with an exemplary embodiment, this occurs approximately 5 ms after the initial activation of the inflator. At approximately 10 ms after the initial activation of the inflator, and if sensing element 62 provides the appropriate signal, the second stage is fired wherein full deployment of the inflatable cushion occurs. It is, of course, understood that the aforementioned time periods are provided as non-limiting examples and the present invention is intended to be used with time periods greater or less than the aforementioned values. In addition, it is also understood that the microprocessor of the sensing and diagnostic module may, in an alternative embodiment, have logic for determining and providing the time delays between the first and second stages of inflation, wherein such timing or time periods between the first stage and the second stage may wary the total outputs of the initiators and the inflator.

In summation and in accordance with an exemplary embodiment illustrated in FIGS. 2A-5C, a small very low mass foam deployable member (e.g., 1-2 grams) is launched into the “zone” of the deploying inflatable cushion. The foam deployable member is connected via a string to a small shorting clip connector wherein the airbag controller will monitor this connection. If the zone is clear, the deployable member will quickly reach the end of the string, pulling the shorting clip from the connector and the resulting electrical signal is used by the airbag controller to enable the second stage of the airbag. If the deployment is obstructed, the deployable member will contact and rebound (bounce) off of the occupant or other obstacle and the remaining energy after blockage is not sufficient to pull the shorted connection apart. At this point no signal is received by the airbag controller and the second stage is suppressed. An exemplary configuration for use with this device is a mid mounted passenger airbag, which includes a plenum around the inflator with a launch tube. The inflation gas of the first stage will pressurize the plenum and the launch tube and this inflation gas will also open the deployment door. At that point the deployable member escapes toward the zone. An opening in the cushion or a configuration of the cushion allows the deployable member to precede the leading edge of the cushion. The cushion opening can be constructed from overlapping fabric flaps that will close as the cushion fills.

The deployable member travels very fast to give a signal in under 5 ms this approach allows a very low first inflation stage to be used (e.g., 30% or less of the total inflation) as well as a very fast enable decision for the second stage that allows the airbag inflation to “catch up” for in-position occupants (e.g., 7 ms the signal is received and the second stage is fired), wherein the cushion fills normally with a fabric flap closing over the opening provided for the deployable member. The foam projectile is shaped like a mushroom to provide a blunt contact surface.

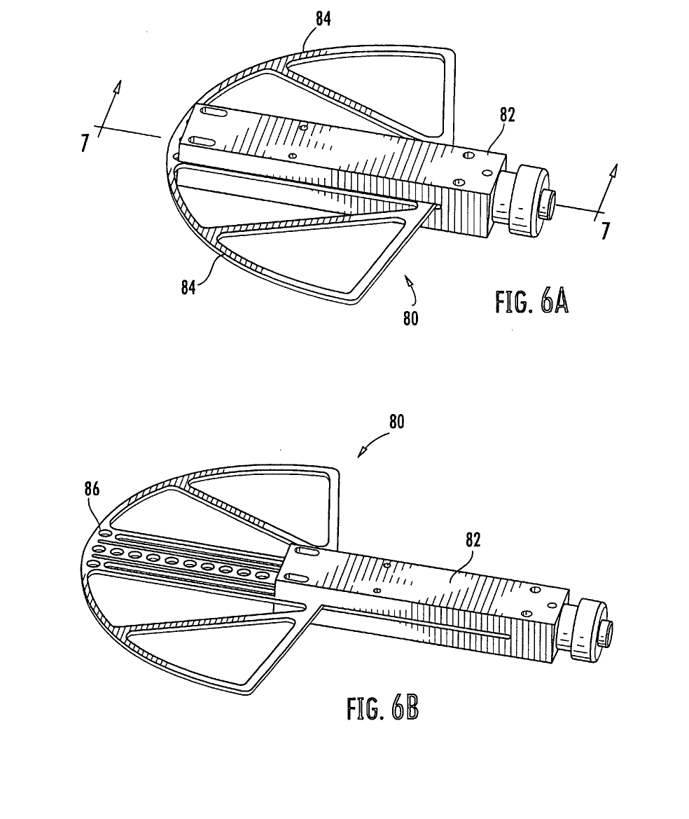

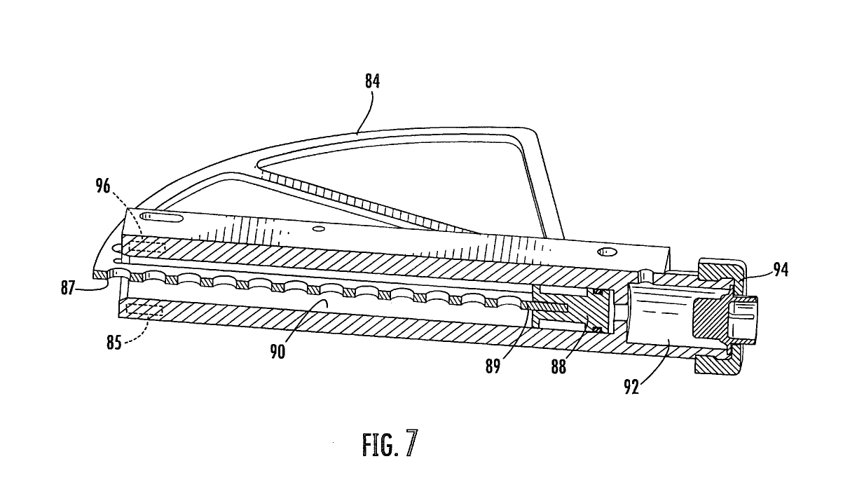

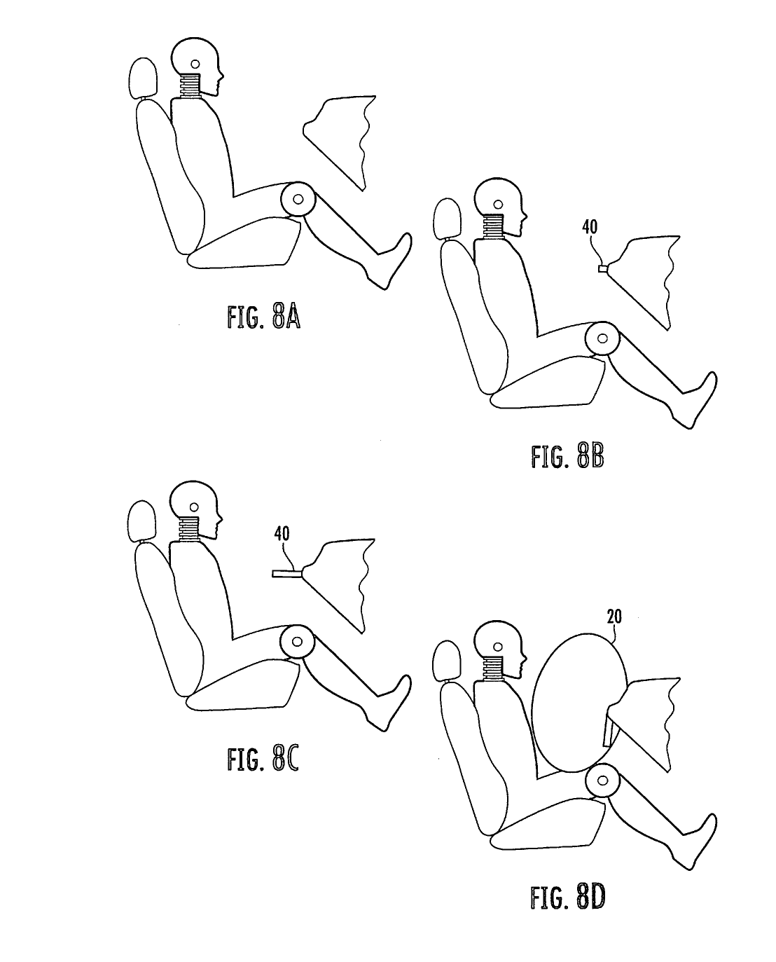

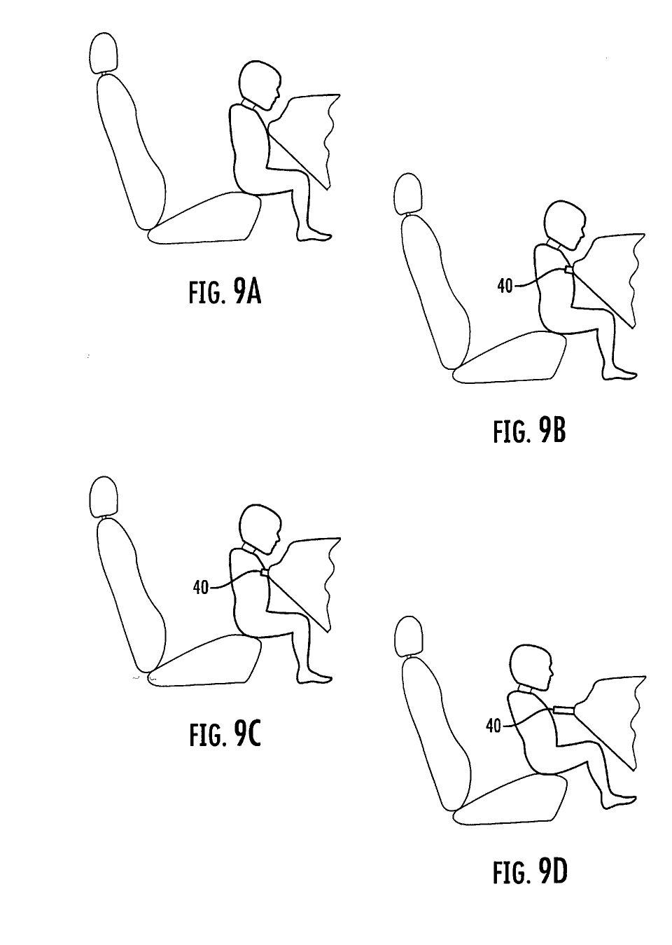

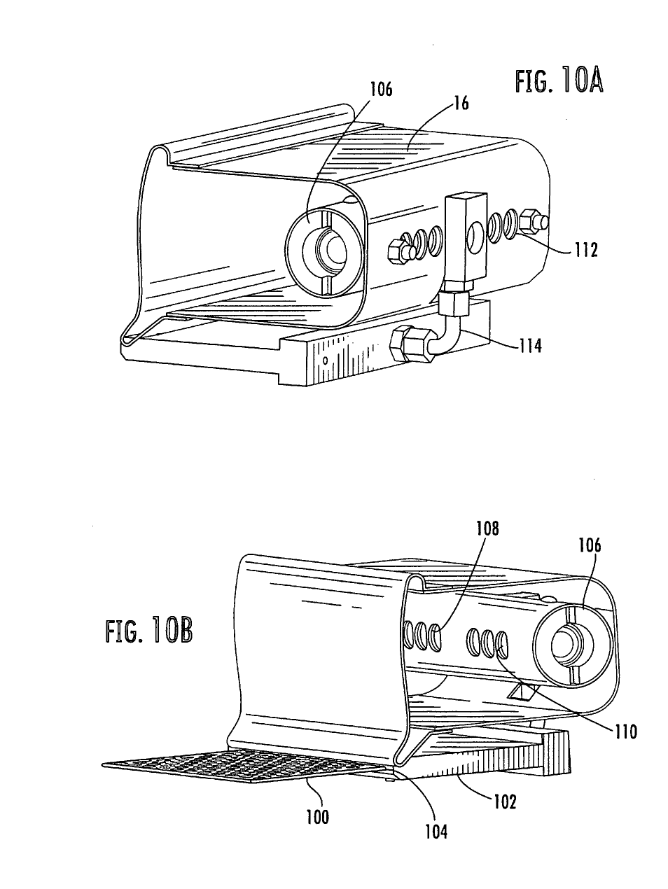

Referring now to FIGS. 6A-9D an alternative exemplary embodiment of the present invention is illustrated. Here deployable member 40 is a plate element 80 configured for deployment out of a housing 82. Housing 82 is located proximate to the airbag module and the plate element is configured for deployment through an opening in the instrument panel. Plate element further comprises a pair of wing portions 84, which are secured to a central member 86. Wing portions 84 provide the deployable member with a larger detection or contact surface. Central member 86 is secured to a piston 88 that is slidably received within a plenum 90. Plenum 90 is in fluid communication with a squib chamber 92, which houses a squib 94 wherein inflation forces of the squib are passed from the squib chamber to the plenum in order to drive the plate element away from the housing by moving the piston within the plenum. In order to determine whether the plate element has traveled a predetermined distance away from the airbag module and to indicate an un-obstructed inflatable cushion deployment opening, a sensor 96 is positioned to detect movement of the plate element. In accordance with an exemplary embodiment, the sensor comprises an electrical connector secured to a portion of the plate element at one end a circuit at the other wherein movement of the plate element will cause the sensor to output a signal indicative of an un-obstructed plate element (e.g., breaking a conductive path). In one exemplary embodiment a signal is provided when the plate has reached its maximum point of travel (e.g., the position illustrated in FIG. 6B). In one non-limiting example, and as previously illustrated in FIG. 4C, the plate element is secured to a shorting clip, which is pulled for a sensor when the plate has reached its maximum point of travel, which in this embodiment will provide a signal to the sensing and diagnostic module when a conductive path between a pair of terminals of the sensor is removed by the movement of shorting clip. Securement of the shorting clip to the plate element may occur at any location as long as the desired movement of the plate element is detected and the clip is able to be removed from the sensor. Therefore, control logic of the sensing and diagnostic module can be easily configured to determine whether the shorting clip has been removed. It is, of course, understood that the aforementioned sensing element is provided as a non-limiting example and any other means for providing an output signal in response to a fully deployed deployment member is contemplated to be within the scope of the present invention.

For example, another means for determining if the plate element has traveled its full stroke corresponding to unblocked deployment would be to couple the plate element to a conductive member, wherein the conductive member is configured to break or tear when the plate element reaches is fully deployed position. Once broken, the conductive member will no longer provide an electrical path between a first resistor and a second resistor, which are connected in parallel by electrical connectors. Accordingly, when the conductive member provides an electrical path between the first resistor and the second resistor a known resistance is provided. However, when plate element reaches an unobstructed deployment configuration, a force is applied to the conductive member such that the conductive path between the first resistor and the second resistor is no longer available. Accordingly, the resistance encountered by the electrical connectors will be equal to that of the second resistor. Therefore, control logic of the sensing and diagnostic module can be easily configured to determine whether the conductive member has been severed. For example, if each of the resistors has the same resistance, severing of the conductive member will cause the resistance to double. In addition, sensing and diagnostic module can easily determine whether the power has been cut or there is a short-circuit in the system. In each of these cases the control logic of the sensing and diagnostic module will be configured to provide an appropriate output signal.

Alternatively, an optical sensor 96 may be positioned to detect the presence or lack thereof of the piston or the central member within the plenum. For example, optical sensor 96 is positioned to detect light from a light source 85 positioned to provide a detectable light source that passes through a plurality of openings 87 in the central member wherein a portion 89 of the central member located proximate to the piston has no openings thus, no light can pass therethrough and be sensed by the optical sensor, once the central portion is fully extended from the housing. Alternatively, the piston itself may provide the necessary means to block the light being detected by the optical sensor. Accordingly, the lack of detected light by the optical sensor will provide a signal indicative of the deployment of the deployable member. Of course, the aforementioned example is provided as a non-limiting example and other configurations are contemplated. For example, sensor 96 may comprise an internal light source that is passed through openings 87 and reflected back to the sensor.

Another alternative sensing device would comprise a Hall effect sensor positioned at the location depicted by box 96 wherein a magnet is located at portion 89 or on piston 88 and the Hall effect sensor detects the magnetic field of the magnet once the deployable member is fully deployed and a signal is generated. As illustrated and in accordance with an exemplary embodiment, the plate element is a flexible low mass plastic plate with large holes, which in accordance with an exemplary embodiment weighs less than 20 grams. Of course, and if applications required the plate element may weigh more than 20 grams. If the deployment is obstructed, the plate will contact the occupant. The low mass of the plate will have a negligible effect due to contact with the occupant. An exemplary configuration for this embodiment to integrate the same with a mid-mounted airbag module, wherein this configuration allows the plate element to be pushed through a horizontal styling gap above or below the deployable door of the airbag module.

In an alternative embodiment the housing and plate element may comprise a completely separate unit located at a position remote from the airbag module housing wherein the airbag module has a unique orientation with respect to the vehicle interior (e.g., a top mounted airbag modules). In this case a styling gap above a glove box door can be utilized for deployment of the plate element. In accordance with an exemplary embodiment, the plate is designed to push with a maximum force of 500 Newtons on a close proximity occupant. Of course, and as applications require forces greater than 500 Newtons may be provided. This force will move the sensor into a final position in under 5 ms and also should provide some discrimination between an occupant's hand and other body portions. For example, an unsupported hand should be pushed out of the way by the plate element allowing for deployment of the inflatable cushion. A head or chest will have enough mass to remain in place and block the plate sensor.

An example of a deployment sequence with the embodiment of FIGS. 6A-9D is as follows: a first sensor initiates the plate sensor squib instead of the inflator, gas from the squib is used to push the sensor plate through a horizontal styling gap in the instrument panel, when the plate reaches the end of travel (e.g., approximately 100 mm of course distances greater or less than 100 mm are contemplated), an electrical connection is broken. This electrical connection is monitored by the airbag controller and if the electrical connection is broken a “zone is clear” signal is received by the airbag controller (e.g., sensing and diagnostic module) and the airbag inflator is activated for normal deployment (e.g., single or dual stage). In accordance with an exemplary embodiment, the plate will reach its final position within 5 ms so that very little time is need to receive the “zone is clear” signal prior to airbag deployment.

If an occupant or other object is in close proximity to the airbag module the same will block the motion of the plate sensor. An example of this sequence is as follows: the crash sensor initiates the plate sensor squib, gas from the squib is used to push the sensor plate through a horizontal styling gap in the instrument panel and the plate is blocked by the occupant or other object and never reaches the end of travel. In this situation the electrical connection is not broken and the airbag controller does not receive the “zone is clear” signal. Thus, the airbag deployment is suppressed.

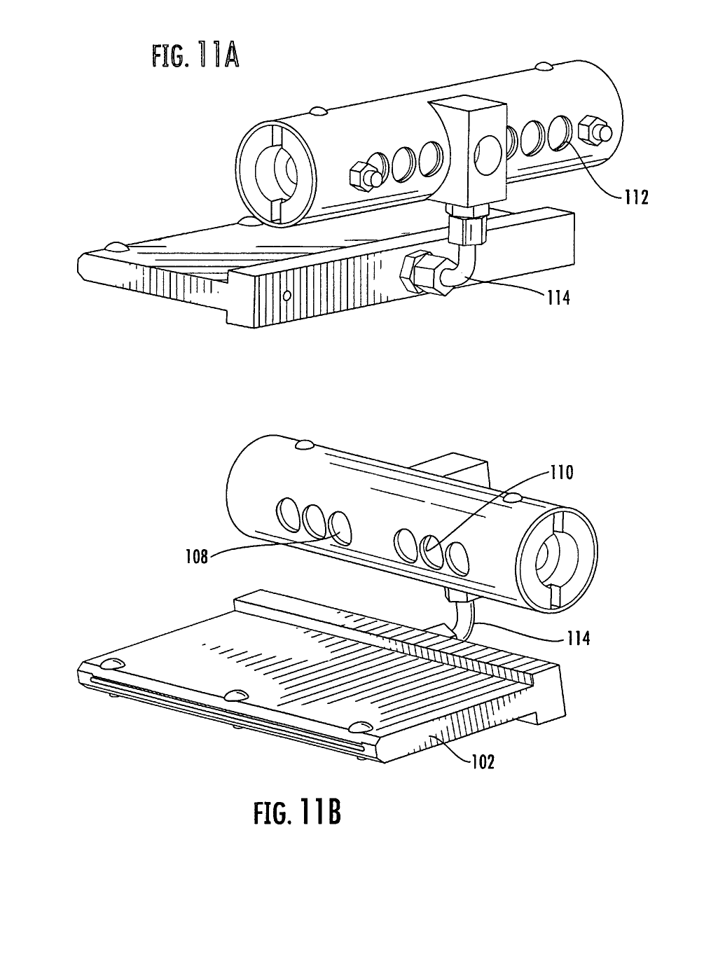

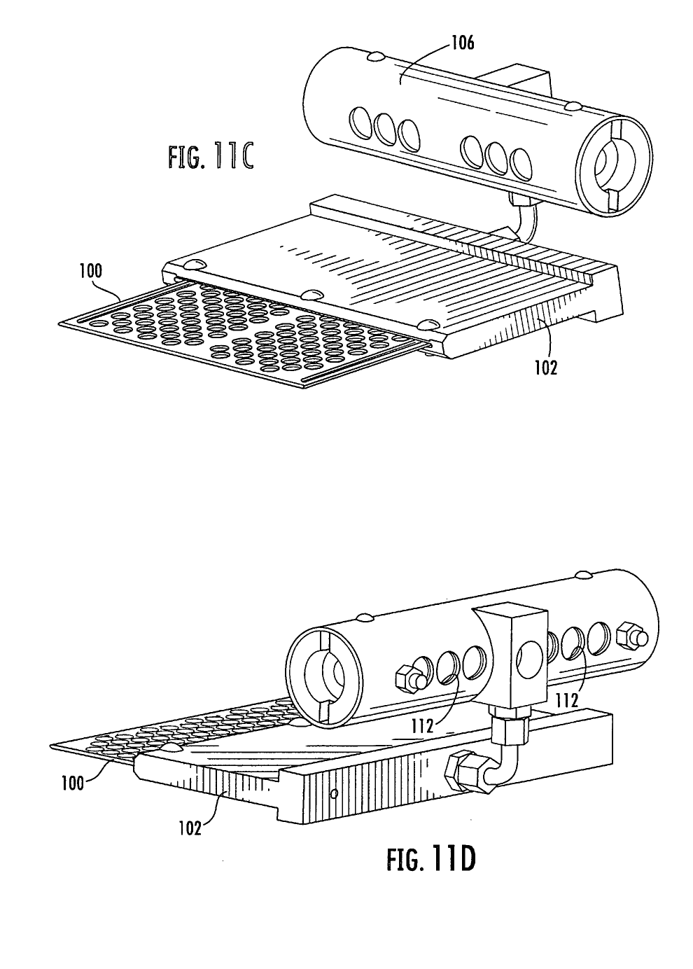

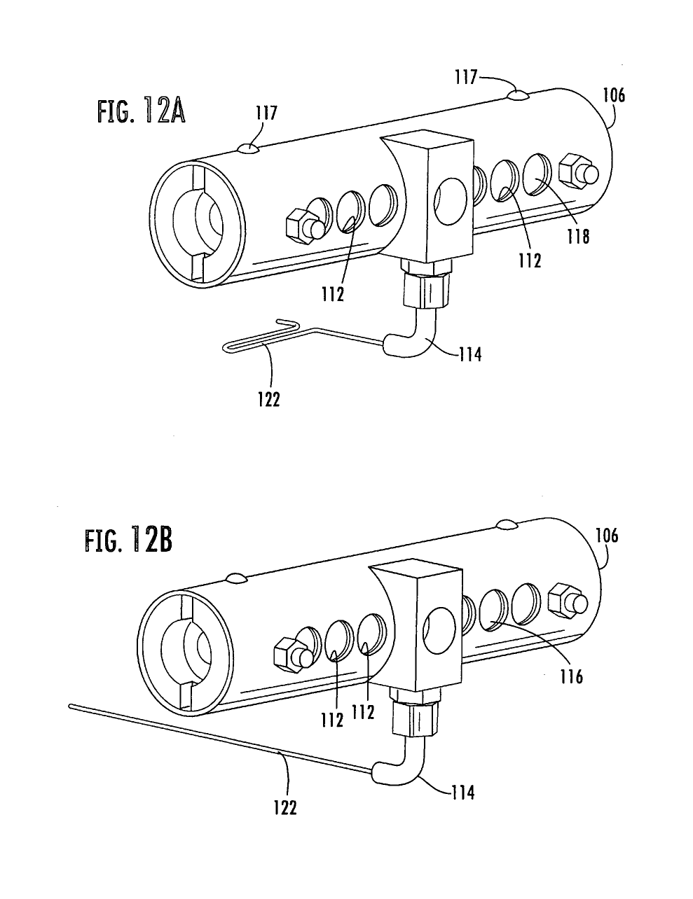

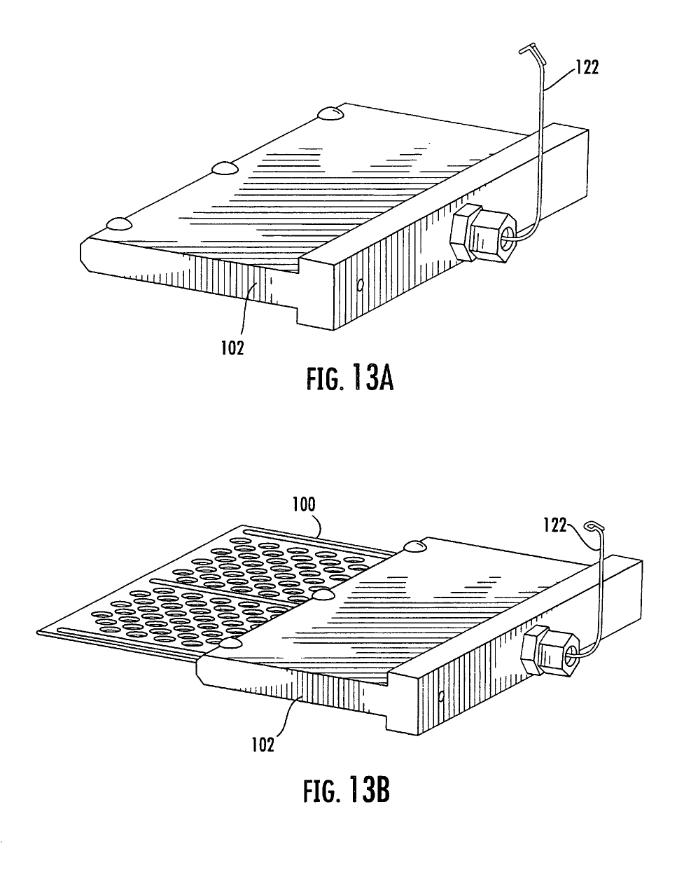

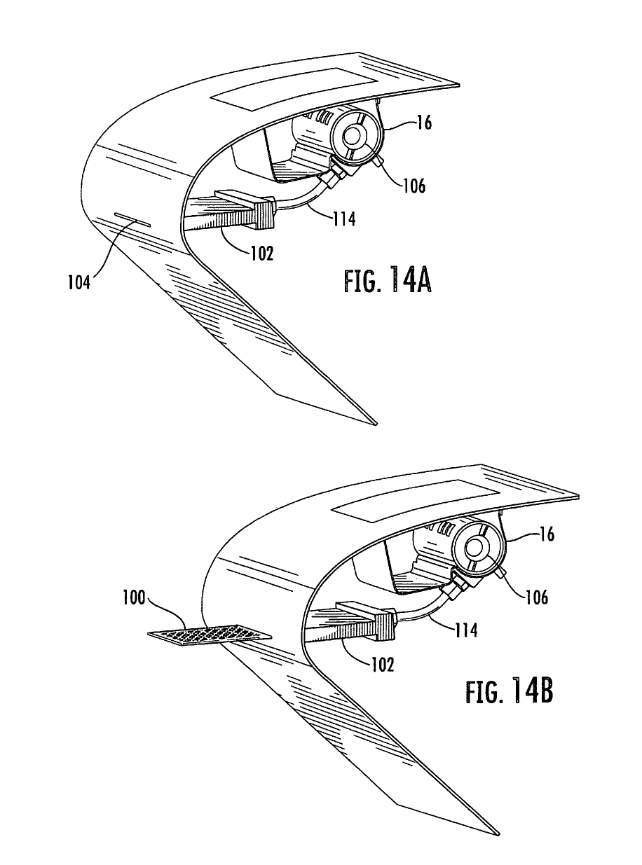

Referring now to FIGS. 10A-14B an alternative exemplary embodiment of the present invention is illustrated here deployable member 40 is again a plate element 100 configured for deployment out of a housing 102. In this embodiment a thin semi-rigid plate projects from the instrument panel toward an area proximate to the airbag module housing. If the plate element is blocked, all inflation gas is vented behind the instrument panel. If the plate element reaches its final extended position all gas is diverted into the airbag cushion for a full inflation. Housing 102 is located proximate to the airbag module and the plate element is configured for deployment through an opening 104 in the instrument panel. In this embodiment, the plate element is driven from the housing by the inflation forces generated by a first stage of inflation of the airbag module as opposed to a separate squib.

In this embodiment, the inflator further comprises a plenum 106 and rotary valve assembly 108, wherein the plenum further comprises a first plurality of plenum ports 110, which are positioned to be in fluid communication with the inflatable cushion (e.g., provide an inflation force to the cushion), a second plurality of plenum ports 112, which are positioned to be in fluid communication with an exterior of the housing (e.g., allow for venting of the inflation force as opposed to directing it to the inflatable cushion), and a conduit or tube 114 providing fluid communication between the plenum and the housing 102 (e.g., drive the plate out of the housing). In addition, the rotary valve assembly comprises a rotatable valve member 116 configured to be rotatable received within plenum 106. In accordance with an exemplary embodiment rotatable valve member 116, will have a plurality of openings 118 configured to align with the second plurality of openings of the plenum in a first position and a plurality of openings 120 configured to align with the first plurality of openings of the plenum in a second position, wherein the plurality of openings 118 are aligned with the second plurality of openings of the plenum in a default positioned such that the inflator and the airbag module is configured to allow a portion of the inflation gas to exhaust out of the housing during a first stage of inflation. In accordance with an exemplary embodiment plenum 106 will have rotation limit bolts 117 or equivalent items in order to provide a means for limiting the rotation of valve member between the first position and the second position or in other words the bolts or equivalent items will protrude into the plenum in order to provide stops for the valve member. In addition, bolts 117 will ensure that either the first plurality of openings or the second plurality of openings are open to allow inflation gas to exhaust from the plenum.

In accordance with an exemplary embodiment un-obstructed deployment of the plate element will cause the rotatable valve member to rotate within the plenum wherein the plurality of openings 118 are no longer aligned with the second plurality of openings in the plenum and the plurality of openings 120 are now aligned with the first plurality of openings in the plenum thereby redirecting the inflation gas into the inflatable cushion. In accordance with an exemplary embodiment rotation of the rotatable valve member is facilitated by securing a cable 122 to a rearward end of the plate element at one end and a portion of the rotatable valve member at the other wherein the cable travels through the conduit providing fluid communication between the housing and the plenum.

A deployment sequence of this embodiment is as follows: a collision sensor initiates the airbag inflator (similar to current systems) wherein gas from the inflator is captured in the plenum surrounding the inflator and forced out the back of the module through a row of holes in the rotary valve member and the housing. The gas also travels down the conduit into a chamber around the plate sensor, wherein the pressure in the chamber is increased and the plate sensor is forced out through a horizontal styling gap in the instrument panel. When the plate reaches the end of the travel (approximately 100 mm of course, and as applications require the distance may be greater or less than 100 mm), the cable becomes taut and rotates the valve body in the inflator plenum. This rotation closes the ports venting the gas through the back portion of the housing while simultaneously opening ports into the inflatable cushion. The remaining gas is then directed into the inflatable cushion causing a normal deployment. In accordance with an exemplary embodiment, the plate movement and valve rotation occur will occur within 10 ms so that very little gas is expelled through the rear portion of the housing when unobstructed deployment of the plate number occurs.

In accordance with an exemplary embodiment and when a close proximity occupant is positioned to block the movement of the plate sensor away from the housing to block deployment sequence occurs. A blocked deployment sequence can be described as follows: the collision sensor initiates the airbag module inflator wherein gas from the inflator is captured in the plenum surrounding the inflator and forced out the back of the module through a row of holes in the rotary valve and the housing. The gas also travels down the tube and pushes on the plate sensor until the plate sensor is forced from a horizontal styling gap in the instrument panel. The plate is then blocked by the occupant and never reaches the end of travel thus, the cable does not become taut and the valve body is not rotated and the remaining gas is vented out of the back of the airbag module. In this scenario, the airbag deployment is suppressed because the cushion never receives any inflation gas.

In accordance with an exemplary embodiment, the plate sensor is a flexible low mass plastic plate with a plurality of holes wherein the total weight of the plate sensor is <20 grams of course, and as applications require, plate sensors greater than 20 grams are contemplated. If the deployment area is obstructed, the plate will contact the occupant or other object wherein the low mass of the plate will have a negligible effect due to contact with the occupant. An exemplary configuration for this embodiment to integrate the same with a mid-mounted airbag module, wherein this configuration allows the plate element to be pushed through a horizontal styling gap above or below the deployable door of the airbag module. This configuration also allows the rotary valve plenum and plate housing to be integrated into the airbag canister with an aluminum extrusion design. The plate is designed to push with a maximum force of 500 Newtons on a close proximity occupant. This force will move the sensor into final position in less than 5 ms and also should provide some discrimination between an occupant's hand or other body portion wherein an unsupported hand will be pushed out of the way by the sensor allowing normal deployment. In contrast, an occupant's head or chest will have enough mass to remain in place and block the plate sensor.

Non-limiting examples of the time of travel of the plate in this embodiment are as follows: if unobstructed, the plate element will reach its end of stroke in approximately 8 ms after the firing of the inflator and the rotary inflation valve will be turned by the movement of the plate and all of the remaining inflation gas will be directed into the cushion. Thereafter, and at approximately 10 ms after the initial firing, a second stage, if needed and if applicable (e.g., dual stage inflator etc.) of the inflator is fired.

On the other hand, if there is an obstruction the plate element is blocked and this will occur at approximately 4 ms after the initiator has been fired (e.g., plate does not deploy fully out of the housing) and all remaining inflator gas is exhausted behind instrument panel regardless of whether a second stage is available and employed. It is, of course, understood that the aforementioned time sequences are merely provided as non-limiting examples, wherein values greater or less than those mentioned herein are contemplated and exemplary embodiments of the present invention are not intended to be limited by the same.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An air bag module, comprising:
an inflatable cushion being configured for deployment from the air bag module;
an inflator for inflating the inflatable cushion, the inflator being in fluid communication with the inflatable cushion, the inflator comprising a first initiator for initiating a first stage of inflation and a second initiator for use with the first initiator for initiating a second stage of inflation, the first stage of inflation providing a first inflation output to the inflatable cushion and the second stage producing a second inflation output to the inflatable cushion, the second inflation output being greater than the first inflation output;
a deployable member, the deployable member being deployed in a first direction either before or during the first stage of inflation; and
wherein unobstructed deployment of the deployable member in the first direction will cause an activation signal to be sent to the second initiator to initiate the second stage of inflation.

2. The air bag module as in claim 1, further comprising a sensing device operably coupled to the deployable member, the sensing device further comprising a sensing element that provides a signal to a sensing and diagnostic module wherein the sensing and diagnostic module provides the activation signal to the second initiator when the deployable member deploys in an unobstructed manner.

3. The air bag module as in claim 1, wherein the deployable member is a foam plug located in a tube, the tube being open on one end and in fluid communication with the inflator on the other end, wherein a portion of the first inflation output causes the foam plug to deploy from the tube.

4. The air bag module as in claim 1, wherein the inflatable cushion is disposed about the deployable member and the inflatable cushion further comprises an opening configured to allow the deployable member to deploy through the inflatable cushion and the inflatable cushion further comprises at least one flap to cover the opening after the deployable member has been deployed through the opening.

5. The air bag module as in claim 1, further comprising a cord secured to the foam plug at one end and an electrical connector at the other end, the electrical connector being removably secured to a terminal, wherein the electrical connector is removed from the terminal when the foam plug travels a predetermined distance from the air bag module and pulls the electrical connector from the terminal.

6. The air bag module as in claim 5, further comprising a sensing and diagnostic module operably coupled to the terminal, the sensing and diagnostic module provides an activation signal to the second initiator when the deployable member deploys in an unobstructed manner and pulls the electrical connector from the terminal.

7. The air bag module as in claim 1, further comprising a diffuser housing, the diffuser housing being configured to receive the inflator therein and wherein the deployable member is a foam plug located in a tube, the tube being open on one end and in fluid communication with the inflator on the other end, the tube being integrally formed with the diffuser and wherein a portion of the first inflation output causes the foam plug to deploy from the tube.

8. The air bag module as in claim 7, wherein the tube is centrally located with respect to the inflatable cushion, when the inflatable cushion is in an un-inflated state and the foam plug weighs less than 2 grams and has a blunt portion and a cylindrical portion, the cylindrical portion being configured to be received within the tube.

9. The air bag module as in claim 7, wherein the tube is centrally within the inflatable cushion and the foam plug is deployed through an opening in the inflatable cushion and the inflatable cushion further comprises at least one flap to cover the opening after the deployable member has been deployed through the opening.

10. The air bag module as in claim 1, further comprising a sensing device operably coupled to the deployable member, the sensing device further comprising a sensing element that provides a signal to a sensing and diagnostic module wherein the sensing and diagnostic module provides the activation signal to the second initiator when the deployable member deploys in an unobstructed manner and wherein the deployable member is a foam plug located in a tube, the tube being open on one end and in fluid communication with the inflator on the other end, wherein a portion of the first inflation output causes the foam plug to deploy from the tube, the foam plug further comprising a cord secured at one end and an electrical connector at the other end, the electrical connector being removably secured to a terminal, wherein the electrical connector is removed from the terminal when the foam plug travels a predetermined distance from the air bag module and pulls the electrical connector from the terminal.

11. An air bag module, comprising:
an inflatable cushion being configured for deployment from the air bag module;
an inflator for inflating the inflatable cushion, the inflator being in fluid communication with the inflatable cushion, the inflator comprising an initiator for initiating inflation of the inflatable cushion;
a deployable member, the deployable member being deployed in a first direction before inflation of the inflatable cushion; and
wherein unobstructed deployment of the deployable member in the first direction will cause an activation signal to be sent to the initiator to initiate the inflation of the inflatable cushion.

12. The air bag module as in claim 11, wherein the deployable member is a plate element located in a squib housing, the squib housing being open on one end and in fluid communication with a squib on the other end, wherein activation of the squib deploys the plate element out of the squib housing.

13. The air bag module as in claim 12, wherein the plate element comprises a central portion and a pair of wing portions depending outwardly from the central portion.

14. The air bag module as in claim 12, wherein the squib housing further comprises: a plenum disposed between the open end and a squib chamber, the squib chamber being in fluid communication with the squib and the plenum; and a piston slidably received within the plenum the piston being secured to the central portion of the plate element, wherein activation of the squib causes the piston to travel through the plenum towards the open end.

15. The air bag module as in claim 14, wherein the central portion has a plurality of openings disposed therein.

16. The air bag module as in claim 11, wherein the plate element is operably coupled to a switch element configured to provide a signal when the plate element has been deployed a predetermined distance, wherein the signal is provided to a sensing and diagnostic module configured to provide a suppression signal if the signal is received.

17. The air bag module as in claim 16, wherein the switch element comprises a portion of a conductive path and the conductive path is broken when the plate element has been deployed the predetermined distance.

18. The air bag module as in claim 16, wherein the predetermined distance is at least 100 mm and the plate weighs less than 20 grams.

19. The air bag module as in claim 15, further comprising a housing configured to receive and enclose the inflator and the inflatable cushion, wherein the squib housing is positioned adjacent to an exterior surface of the housing.

20. The air bag module as in claim 19, wherein the plate element is configured to deploy through an opening in an instrument panel disposed over the air bag module.

21. An air bag module, comprising:
an inflatable cushion being configured for deployment from the air bag module;
an inflator for inflating the inflatable cushion, the inflator being disposed within a plenum, the plenum comprising a first plurality of openings in fluid communication with the inflatable cushion, a second plurality of openings in fluid communication with an exterior of the airbag module; and a conduit in fluid communication with a plate housing;
a deployable member slidably received within the plate housing, the deployable member being deployed in a first direction during activation of the inflator;
a rotary valve rotatably disposed within the plenum the rotary valve being configured to transition from a first position to a second position, wherein the first plurality of openings are blocked by the rotary valve in the first position and second plurality of openings are unblocked by the rotary valve in the first position; and
wherein unobstructed deployment of the deployable member in the first direction will cause the rotary valve to transition from the first position to the second position, wherein the first plurality of openings are unblocked by the rotary valve in the second position and the first plurality of openings are blocked by the rotary valve in the second position.

22. The air bag module as in claim 21, wherein the plate element is secured to the rotary valve by a cable.

23. The air bag module as in claim 21, wherein the plate element has a width similar to a corresponding width of a housing of the airbag module and the plate element weighs less than 20 grams.

24. The air bag module as in claim 21, wherein the predetermined distance is at least 100 mm.

25. The air bag module as in claim 21, further comprising a housing configured to receive and enclose the inflator and the inflatable cushion, wherein the plate housing is positioned adjacent to an exterior surface of the housing.

26. The air bag module as in claim 25, wherein the plate element is configured to deploy through an opening in an instrument panel disposed over the air bag module.

27. A proximity detection device disposed proximate to an inflatable cushion of an air bag module, the proximity detection device comprising:
a deployable member, the deployable member being deployed in a first direction either before or during inflation of the inflatable cushion; and
wherein unobstructed deployment of the deployable member in the first direction will cause an inflation output to the inflatable cushion to be increased.

28. The proximity detection device as in claim 27, wherein the deployable member is a foam plug located in a tube, the tube being open on one end and in fluid communication with an inflator on the other end, wherein a portion of an inflation output of the inflator causes the foam plug to deploy from the tube.

29. The proximity detection device as in claim 28, further comprising a cord secured to the foam plug at one end and an electrical connector at the other end, the electrical connector being removably secured to a terminal, wherein the electrical connector is removed from the terminal when the foam plug travels a predetermined distance from the air bag module and pulls the electrical connector from the terminal.

30. The proximity detection device as in claim 29, further comprising a sensing and diagnostic module operably coupled to the terminal, the sensing and diagnostic module provides an activation signal to the inflator when the deployable member deploys in an unobstructed manner and pulls the electrical connector from the terminal.

31. The proximity detection device as in claim 27, wherein the deployable member is a plate element located in a squib housing, the squib housing being open on one end and in fluid communication with a squib on the other end, wherein activation of the squib deploys the plate element out of the squib housing.

32. The proximity detection device as in claim 31, wherein the plate element comprises a central portion and a pair of wing portions depending outwardly from the central portion.

33. The proximity detection device as in claim 32, wherein the squib housing further comprises: a plenum disposed between the open end and a squib chamber, the squib chamber being in fluid communication with the squib and the plenum; and a piston slidably received within the plenum the piston being secured to the central portion of the plate element, wherein activation of the squib causes the piston to travel through the plenum towards the open end.

34. The proximity detection device as in claim 33, wherein the plate element is operably coupled to a switch element configured to provide a signal when the plate element has been deployed a predetermined distance.

35. The proximity detection device as in claim 27, wherein the deployable member is a plate element located in a housing in fluid communication with an inflator for inflating the inflatable cushion, the inflator being disposed within a plenum, the plenum comprising a first plurality of openings in fluid communication with the inflatable cushion, a second plurality of openings in fluid communication with an exterior of the airbag module and a rotary valve rotatably disposed within the plenum, the rotary valve being configured to transition from a first position to a second position, wherein the first plurality of openings are blocked by the rotary valve in the first position and second plurality of openings are unblocked by the rotary valve in the first position; wherein the plate element deploys in the first direction before inflation of the inflatable cushion and unobstructed deployment of the deployable member in the first direction will cause the rotary valve to transition from the first position to the second position, wherein the first plurality of openings are unblocked by the rotary valve in the second position and the first plurality of openings are blocked by the rotary valve in the second position.

36. The proximity detection device as in claim 37, wherein the plate element is secured to the rotary valve by a cable.

37. The proximity detection device as in claim 37, wherein the plate element weighs less than 20 grams.

38. A method for determining whether a portion of an inflatable cushion of an airbag module is obstructed, the method comprising:
deploying a deployable member in a first direction;
increasing an inflator output to the inflatable cushion if the deployable member reaches a predetermined distance, wherein the deployable member is not an inflatable item.

39. The method as in claim 38, wherein the inflatable cushion is disposed about the deployable member and the inflatable cushion further comprises an opening configured to allow the deployable member to deploy through the inflatable cushion and the inflatable cushion further comprises at least one flap to cover the opening after the deployable member has been deployed through the opening, wherein the deployable member is a foam plug located in a tube, the tube being open on one end and in fluid communication with the inflator on the other end, wherein a portion of the first inflation output causes the foam plug to deploy from the tube, the foam plug further comprising a cord secured at one end and an electrical connector at the other end, the electrical connector being removably secured to a terminal, wherein the electrical connector is removed from the terminal when the foam plug travels the predetermined distance from the air bag module and pulls the electrical connector from the terminal.

40. The method as in claim 38, wherein the deployable member is a plate element located in a housing in fluid communication with the inflator, the inflator being disposed within a plenum, the plenum comprising a first plurality of openings in fluid communication with the inflatable cushion, a second plurality of openings in fluid communication with an exterior of the airbag module and a rotary valve rotatably disposed within the plenum, the rotary valve being configured to transition from a first position to a second position, wherein the first plurality of openings are blocked by the rotary valve in the first position and second plurality of openings are unblocked by the rotary valve in the first position; wherein the plate element deploys in the first direction before inflation of the inflatable cushion and unobstructed deployment of the deployable member in the first direction will cause the rotary valve to transition from the first position to the second position, wherein the first plurality of openings are unblocked by the rotary valve in the second position and the first plurality of openings are blocked by the rotary valve in the second position.

41. The method as in claim 38, wherein the deployable member is a plate element located in a squib housing, the squib housing being open on one end and in fluid communication with a squib on the other end, wherein activation of the squib deploys the plate element out of the squib housing and the plate element comprises a central portion and a pair of wing portions depending outwardly from the central portion, wherein the squib housing further comprises: a plenum disposed between the open end and a squib chamber, the squib chamber being in fluid communication with the squib and the plenum; and a piston is slidably received within the plenum the piston being secured to the central portion of the plate element, wherein activation of the squib causes the piston to travel through the plenum towards the open end.
